(19) United States
(12) Patent Application Publication
(10) Pub. No.: US 2018/0167461 A1
(43) Pub. Date: Jun. 14, 2018

(54) METHOD AND APPARATUS FOR LOAD BALANCING

(71) Applicant: ALIBABA GROUP HOLDING LIMITED, George Town (KY)

(72) Inventor: Chunhui SHEN, Hangzhou (CN)

(21) Appl. No.: 15/890,319

(22) Filed: Feb. 6, 2018

Related U.S. Application Data
(63) Continuation of application No. PCT/CN2016/091521, filed on Jul. 25, 2016.

(30) Foreign Application Priority Data
Aug. 6, 2015 (CN) 201510477498.5

(51) Int. Cl. H04L 29/08; G06F 9/50; H04L 12/26

(52) U.S. Cl. CPC H04L 67/1097; G06F 9/505; H04L 41/147; H04L 43/0882; H04L 67/101

(57) ABSTRACT

A method for load balancing a set of servers has been disclosed. The method comprises acquiring a data localization rate of each region on each server of the set of servers, wherein the data localization rate is based on amount of local data of each region stored on a physical machine corresponding to a server and amount of total data of each region, determining a target server for a region using the data localization rate for each region on each server, and migrating the region to the target server, in response to the server that the region is currently located at being different from the target server for the region.

### CROSS REFERENCE TO RELATED APPLICATION

The present application claims priority to International Application No. PCT/CN2016/091521, filed Jul. 25, 2016, which is based on and claims the benefits of priority to Chinese Application No. 201510477498.5, filed Aug. 6, 2015, both of which are incorporated herein by reference in their entireties.

### TECHNICAL FIELD

The present application relates to the field of computers, and in particular, to a load balancing method and device.

### BACKGROUND

In a distributed data storage system, a data table is sliced according to a lexicographic order where each slice is referred to as one region. These regions are distributed on servers in a cluster. Uniformly distributing and/or dynamically adjusting these regions can be problematic for current implementations of load balancing provided in a distributed data storage system. The effectiveness of a load balancing directly affects the uniformity of data storage and the uniformity of service read and write requests. In an extreme circumstance, if balancing fails and all regions are scheduled to one physical machine, the service capability of the entire cluster equals the service capability of the one physical machine, and consequently the cluster has the same performance as a single machine.

In load balancing implementations for an existing distributed storage system, balancing based on a region load quantity is generally used. One objective of load balancing is to make quantities of regions on servers to be basically very close or the same. Basically, region load quantities on all servers are first acquired, an average region load quantity on each server is calculated, and a region on a server with an excessively large region load quantity migrates to a server with an excessively small region load quantity, to implement load balancing. After some physical machines in the system are restarted, regions are reallocated. In such a process, only the factor of a region load quantity is considered in the current load balancing implementations. As a result, a region has the same probability of being allocated to different servers. In this case, a probability that data in a region is remotely read is greatly increased. During a remote read, disk data on a remote server needs to be accessed. Compared with a local read, a remote read requires extra network overheads. Therefore, the read performance is relatively poor.

Therefore, when the existing load balancing method is used to perform load balancing on a distributed storage system, a data localization rate after region allocation is not high, causing relatively poor read performance of the entire system.

### SUMMARY

In some embodiments of the present disclosure, a method for load balancing a set of servers has been disclosed. The method comprises acquiring a data localization rate of each region on each server of the set of servers, wherein the data localization rate is based on amount of local data of each region stored on a physical machine corresponding to a server and amount of total data of each region, determining a target server for a region using the data localization rate for each region on each server, and moving the region to the target server, in response to the server that the region is currently located at being different from the target server for the region.

In some embodiments of the disclosure, a device for load balancing a set of servers has been disclosed. The device comprises a localization rate acquisition apparatus configured to acquire a data localization rate of each region on each server of the set of servers, wherein the data localization rate is based on amount of local data of each region stored on a physical machine corresponding to a server and amount of total data of each region, a target determination apparatus configured to determine a target server for a region using the data localization rate for each region on each server, and a region migration apparatus configured to move the region to the target server, in response to the server that the region is currently located at being different from the target server for the region.

In some embodiments of the disclosure, a non-transitory computer readable medium storing a set of instructions that is executable by one or more processors of a load balancing system to cause the system to perform a method has been disclosed. The method comprises acquiring a data localization rate of each region on each server of the set of servers, wherein the data localization rate is based on amount of local data of each region stored on a physical machine corresponding to a server and amount of total data of each region, determining a target server for a region using the data localization rate for each region on each server, and moving the region to the target server, in response to the server that the region is currently located at being different from the target server for the region.

### BRIEF DESCRIPTION OF THE DRAWINGS

Other features, objectives, and advantages of the present application will become more obvious by reading detailed descriptions of the non-limitative embodiments with reference to the following accompanying drawings:

FIG. 1 is a schematic diagram illustrating an exemplary storage topology of a distributed data storage system based on a distributed file system, consistent with embodiments of the present disclosure.

FIG. 2 is a flow chart illustrating an exemplary process of a load balancing method, consistent with embodiments of the present disclosure.

FIG. 3 is a flow chart illustrating an exemplary load balancing method, consistent with embodiments of the present disclosure.

FIG. 4 is a flow chart illustrating an exemplary load balancing method, consistent with embodiments of the present disclosure.

FIG. 5 is a schematic diagram illustrating an exemplary load balancing device, consistent with embodiments of the present disclosure.

FIG. 6 is a schematic diagram illustrating an exemplary load balancing device, consistent with embodiments of the present disclosure.

FIG. 7 is a schematic diagram illustrating an exemplary load balancing device, consistent with embodiments of the present disclosure.

The same or similar reference numerals in the accompanying drawings represent the same or similar parts.

### DETAILED DESCRIPTION

The present application is further described below in detail with reference to the accompanying drawings.

In a typical configuration of the present application, a terminal, a device of a service network, and a trustee all include one or more processors (CPU), an input/output interface, a network interface, and a memory.

The memory may be a computer readable medium in a form of a volatile memory, a random-access memory (RAM) and/or a non-volatile memory, for example, a read-only memory (ROM) or a flash memory (flash RAM). Memory is an example of computer readable medium.

The computer readable medium includes non-volatile and volatile media as well as movable and non-movable media, and may implement information storage by means of any method or technology. Information may be a computer readable instruction, a data structure, a module of a program or other data. An example of the computer storage medium includes, but is not limited to, a phase-change memory (PRAM), a static RAM (SRAM), a dynamic RAM (DRAM), another type of RAM, a ROM, an electrically erasable programmable ROM (EEPROM), a flash memory or another memory technology, a compact disc ROM (CD-ROM), a digital versatile disc (DVD) or another optical storage, a cassette tape, a magnetic tape, a disk storage or another magnetic storage device or any other non-transmission medium, and may be configured to store information accessible to a computing device. As defined herein, the computer readable medium does not include a non-temporary computer readable medium (transitory media), for example, a modulated data signal or carrier.

In existing load balancing implementations, balancing based on a region load quantity is generally used where only the factor of a region load quantity is considered. As a result, a region has the same probability of being allocated to different servers during reallocation. Therefore, this can cause a relatively low data localization rate of the region on the server where the region is located at. A magnetic disk of another physical machine usually needs to be remotely accessed for acquiring data of most data query requests. This greatly reduces the read performance of the system. For example, if random read requests for a physical machine in which a Solid State Drive (SSD) is used are all done locally, a Query Per Second (QPS) capability that can be provided can reach 30000 times. If random read requests are all done remotely and a 100 MB/S capability provided by a gigabit network adapter is assumed, and one random read at least accesses one 16 KB data block, a QPS capability that can be provided can only reach 6000 times.

According to some embodiments of the present disclosure, when a QPS throughput is not considered, a remote read has at least 0.5 ms extra overhead as compared with a local read from the perspective of a response delay. Therefore, a data localization rate of a region on each server is acquired, and each region is allocated to a server with the highest localization rate according to the data localization rate. When a data query request is processed, a server to which each region is currently allocated has a relatively high data localization rate and most data can be acquired from a magnetic disk in a local server. As a result, the probability of remotely reading data in a region can be greatly reduced, so that read performance is increased.

In a distributed data storage system based on a distributed file system, for example, a Hadoop Database (Hbase) based on a Hadoop Distributed File System (HDFS), a region is a data unit obtained by slicing one logic table according to a preset rule. Regions do not have an intersection. All regions together form one complete logic table. One region includes multiple files, with each file including multiple data blocks. A data block is the basic unit of a physical storage. In a distributed file system, each data block has multiple copies, and the multiple copies are allocated to multiple servers of the distributed file system for redundancy storage.

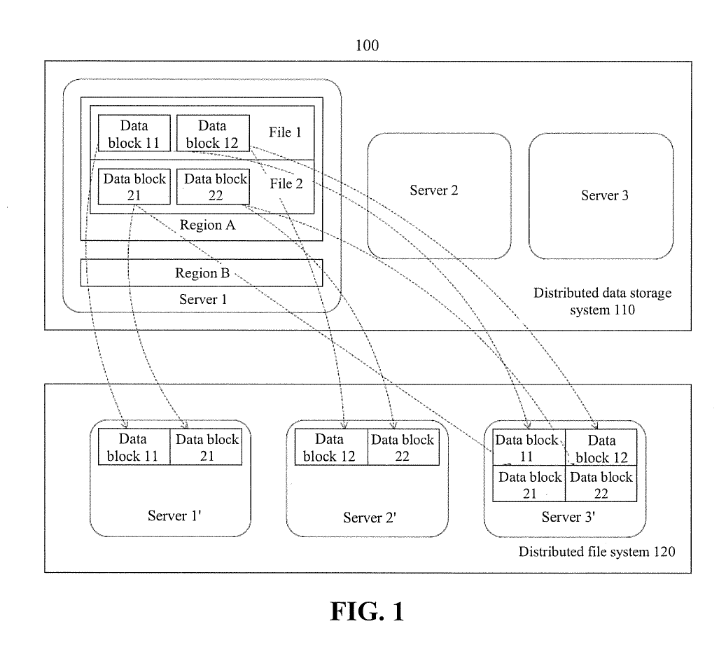

Reference is now made to FIG. 1, which is a schematic diagram illustrating an exemplary storage topology 100 of a distributed data storage system 110 based on a distributed file system 120, consistent with embodiments of the present disclosure.

Distributed data storage 110 system includes three servers (server 1, server 2, and server 3). Multiple regions are allocated on each server. For example, regions on server 1 are region A and region B. Each region includes multiple files. For example, region A includes file 1 and file 2. Further, file 1 includes data block 11 and data block 12, and file 2 includes data block 21 and data block 22. In distributed file system 120, server 1′ and server 1 are the same physical machine, server 2′ and server 2 are the same physical machine, and server 3′ and server 3 are the same physical machine. Each data block has two copies, which are allocated on servers of distributed file system 120. Two copies of data block 11 are allocated on server 1′ and server 3′, two copies of data block 12 are allocated on server 2′ and server 3′, two copies of data block 21 are allocated on server 1′ and server 3′, and two copies of data block 22 are allocated on server 2′ and server 3′. Therefore, distributions of data localization rates of region A (that is, a data localization rate of region A on each server) is:

$${A}_{Server 1} = \frac{Block 11 + Block 21}{File 1 + File 2}$$

$${A}_{Server 2} = \frac{Block 12 + Block 22}{File 1 + File 2}$$

$${A}_{Server 3} = \frac{Block 11 + Block 12 + Block 21 + Block 22}{File 1 + File 2}$$

wherein AServer1, AServer2, and AServer3 respectively represent data localization rates of region A on server 1, server 2, and server 3. Block11, Block12, Block21, and Block22 respectively represent the sizes of data block 11, data block 12, data block 21, and data block 22. File1 and File2 respectively represent the sizes of file 1 and file 2.

It is appreciated that quantities of various servers, regions, files, and data blocks in FIG. 1 are shown with brevity and may be less than quantities in practical application. However, such an omission undoubtedly is used without affecting clear and thorough disclosure of the present disclosure.

Generally, multiple copies of a same data block of a file have corresponding relation. Storage media for the multiple copies are the same. For example, all copies can be stored in a Hard Disk Drive (HDD) or an SSD. In this case, during calculation of a data localization rate, data blocks on storage media of all physical machines are calculated. However, in a mixed-storage scenario in which storage media for multiple copies are heterogeneous, multiple copies of a same data block of a file have no corresponding relation. For example, one of the two copies of data block 11 is stored in an HDD, and the other one is stored in an SSD. Because the read performance of an SSD is greater than that of an HDD, only the data block stored in the SSD can be calculated during calculation of data localization. For example, for the two copies of data block 11, the copy on server 1′ is stored in an HDD, and the other copy on the server 3′ is stored in an SSD. In this case, only data in the server 3′ is calculated during calculation of a data localization rate, and the data localization rate of region A on server 1 is changed to:

$${A}_{Server 1} = \frac{Block 21}{File 1 + File 2}$$

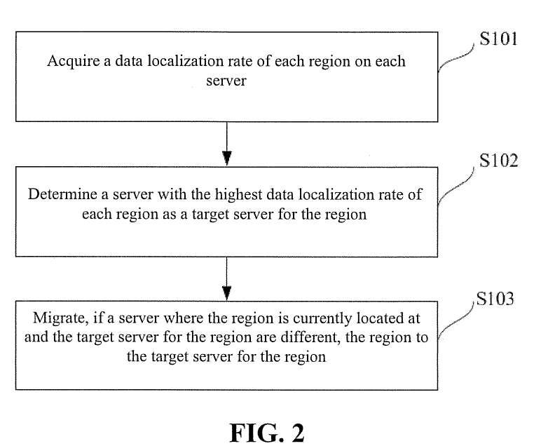

Reference is now made to FIG. 2, which is a flow chart illustrating an exemplary process of a load balancing method, consistent with embodiments of the present disclosure. The method includes the following steps.

At step S101, a data localization rate of each region on each server is acquired. The data localization rate is a ratio of local data of the region stored on a physical machine corresponding to a server to a total data of the region.

At step S102, a server with the highest data localization rate of each region is determined as a target server corresponding to the region.

At step S103, if the server where the region is currently located at and the target server corresponding to the region are different, the region is moved from the location where the region is currently located at to the location where the target server corresponding to the region is located at.

The scenario shown in FIG. 1 is used as an example. A server with the highest data localization rate of each region can be determined according to the data localization rate of each region on each server acquired in step S101. The server is a preferred server of a corresponding region and is used as a target server to which the region is moved. It is assumed that data block 11, data block 12, data block 21, and data block 22 have the same size. Distributions of data localization rates of region A are:

$${A}_{Server 1} = \frac{Block 11 + Block 21}{File 1 + File 2} = 50 \%$$

$${A}_{Server 2} = \frac{Block 12 + Block 22}{File 1 + File 2} = 50 \%$$

$${A}_{Server 3} = \frac{Block 11 + Block 12 + Block 21 + Block 22}{File 1 + File 2} = 100 \%$$

Accordingly, a region migration plan can be generated. Server 3 is determined as the target server of region A. Because the server where region A is currently located at is server 1, which is not the same server as the target server of region A, the region migration plan is executed to move region A to the target server for the region, which is server 3 here. If the server where a region is currently located at and the target server for the region are the same, the server where the region is currently located at already has the highest data localization rate, therefore region migration is unnecessary. After region migration is completed, a data localization rate of region A on server 3 can reach 100%. Accordingly, for any data query request, only local read needs to be performed on a local magnetic disk of a physical machine of server 3 to acquire the required data. Therefore, read performance is greatly improved.

Moreover, quantities of servers, regions, files and data blocks involved in practical application are greater than those shown in FIG. 1. For a server, when data localization rates of several regions are high, the quantity of data blocks of the other regions stored on a physical machine corresponding to the server is generally relatively small because of the storage space restriction. As a result, data localization rates of the other regions on the server are relatively low. Therefore, after region migration is performed according to a data localization rate, the region load quantity on each server is relatively balanced. Servers have similar loads.

Region migration can bring certain processing load to the distributed data storage system 110. To prevent normal operation of the system from being affected by excessive numbers of region migration, migration may not be performed when the migration only slightly increases the data localization rate. In some embodiments, a server with the highest data localization rate of each region is determined as the target server for the region. Determining step S102 of FIG. 2 can further include, if a difference between the data localization rate of a server where a region is currently located at and the data localization rate of a server with the highest data localization rate of the region is greater than a preset value, determining the server with the highest data localization rate of the region as a target server for the region. The preset value may be set according to application scenario, for example, 10%. Therefore, a server with the highest data localization rate is used as the target server only when the difference between the data localization rate of a region on a current server and the highest data localization rate that can be reached is greater than 10%.

Region A of server 1 in FIG. 1 is used as an example. It is assumed that a data localization rate of region A on server 1 where region A is currently located at is 70%, and data localization rates of the region A on the server 2 and the server 3 are respectively 30% and 75%. In this case, for region A, the server with the highest data localization rate is server 3. However, the difference between the highest data localization rate and the data localization rate on the server where the region A is currently located at is 5%. Overall improvement of read performance after region migration is determined to be not significant. Therefore, migration may not be performed. And the target server of region A may be set to be the server where region A is currently located (server 1 in this case). However, if the data localization rate of the region on server 3 reaches 90%, it is determined that data localization rate can be increased by 20% by region migration. In this case, the read performance is significantly improved. Therefore, server 3 is used as the target server of region A.

In some embodiments, a central server in distributed data storage system 110 may perform the disclosed load balancing implementation. A central server can be, but is not limited to, a network host, a single network server, a set of multiple network servers or a Cloud Computing based computer set. A cloud is formed of a large number of hosts or network servers based on cloud computing. Cloud computing is one type of distributed computing, and can be a virtual computer including a group of loosely coupled computer sets. The central server can regularly collect data localization rates of a region on servers in a heartbeat report manner.

After region migration is performed according to the foregoing method, the data localization rate of each region in distributed data storage system 110 may reach the maximum. At the same time, servers may generally have relatively balanced load. However, in a special circumstance such as a data hotspot or system expansion, data may relatively concentrate on some server nodes. In this case, many regions may be loaded on some servers, while a relatively small quantity of regions are loaded on some other servers. As a result, region load quantities are not balanced. In some embodiments of the present disclosure, a load balancing method is further disclosed.

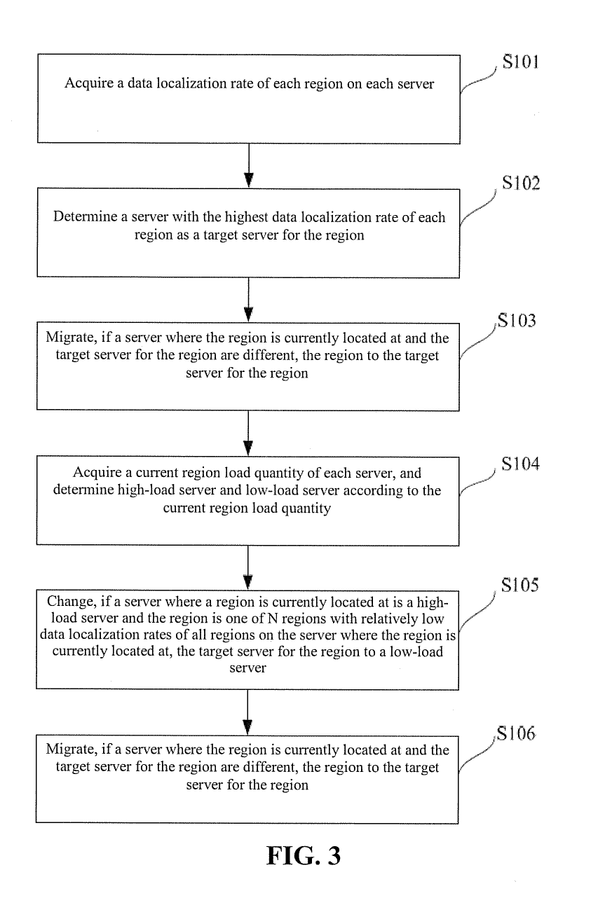

Reference is now made to FIG. 3, which is a flow chart illustrating an exemplary load balancing method, consistent with embodiments of the present disclosure. The processing procedure of the load balancing method includes the following steps.

At step S101, a data localization rate of each region on each server is acquired. The data localization rate is a ratio of local data of the region stored on a physical machine corresponding to a server to total data of the region.

At step S102, a server with the highest data localization rate of each region is determined as a target server corresponding to the region.

At step S103, if the server where the region is currently located at and the target server corresponding to the region are different, the region migrates from the location where the region is currently located at to the location where the target server corresponding to the region is located at.

At step S104, a current region load quantity of each server is acquired, and servers can be determined as high load server, low load server, or the like, according to the current region load quantity.

The low-load server and the high-load server respectively refer to servers where regions are allocated to have region load quantities that are less than and greater than an average region load quantity, respectively. A preset load range may be set according to the average region load quantity. According to the upper limit value and the lower limit value of the preset load range, a server can be determined to be a low-load server or a high-load server. In some embodiments, acquisition step S104 can further comprise acquiring a current region load quantity of each server, determining a server whose current region load quantity is greater than a preset load range's upper limit as a high-load server, and determining a server whose current region load quantity is less than a preset load range's lower limit as a low-load server. For example, the upper limit of the preset load range may be set as the average region load quantity×(1+coefficient), and the upper limit of the preset load range may be set as the average region load quantity×(1+coefficient). The coefficient may be set according to application.

For example, the coefficient is set to 0.1 here. If the average region load quantity is 50 by calculation according to the acquired current region load quantity of each server, the upper limit of the preset load range is 50×(1+0.1)=55, and the lower limit of the preset load range is 50×(1-0.1)=45. Accordingly, a server whose current region load quantity is greater than 55 is determined as a high-load server, and a server whose current region load quantity is less than 45 is determined as a low-load server.

For example, if the current region load quantity of the server 3 is 57, it is determined as a high-load server. If the current region load quantity of the server 1 is 40, it is determined as a low-load server. Several regions with the lowest data localization rates on server 3 may migrate to server 1 to make region load more balanced. In this case, the quantity of migration may be determined according to one or more requirements of the application, and one or more regions may migrate. When only one region with the lowest data localization rate migrates, the load can be balanced, although the region load quantity of server 3 cannot be reduced to the preset load range.

At step S105, if a server where a region is currently located at is a high-load server and the region is one of N regions with relatively low data localization rates of regions on the server where the region is currently located at, the target server for the region is configured to change to a low-load server. Here N is a positive integer.

In some embodiments, a quantity of regions to be moved from a high-load server to a low-load server may be determined according to the average region load quantity. In change step S105, N is the difference between the current region load quantity of the high-load server and an average current region load quantity of all servers. For example, here a quantity of regions that need to be moved from server 3 is 7. If a region is one of the 7 regions with relatively low data localization rates out of all regions on the server where the region is currently located at, the target server for the region is configured to change to server 1. For the other 6 regions that have relatively low data localization rates, the target servers thereof are similarly configured to change to low-load servers.

At step S106, if a server where the region is currently located at and the target server for the region are different servers, the region migrates to the target server for the region.

After region migration is performed according to a data localization rate of the regions, another migration is performed to further take into consideration the region load quantities of all servers, thereby reducing the occurrence of unbalanced region load that may be caused by region migration performed only according to a data localization rate, and leading region load quantities of the servers to reach a more balanced state while ensuring data read performance.

When there are multiple low-load servers, the target server for the region may be configured to change to a low-load server by random allocation. In addition, the target server for the region may also be configured to change to a low-load server with the highest data localization rate of the region according to data localization rates of the region on the low-load servers. For example, server 1 is a high-load server, and server 3, server 4, and server 6 are low-load servers. Region B is a region with the lowest data localization rate on server 1, which is 52%. Data localization rates of region B on server 3, server 4, and server 6 are respectively 40%, 33%, and 17%. Region B can still migrate from a high-load server to a low-load server to ensure balanced region load quantities. During selection of a target server, an optimal server may be selected according to a data localization rate. For example, an optimal low-load server of region B is server 3.

If at step S101, the server where region B is currently located at is server 6, and a data localization rate of region B is 17%. At step S102, it is determined that the target server of region B is server 1, and a data localization rate of region B is 52%. At step S103, region B is migrated to the currently set target server so that region B has a better or optimal data localization rate. However, at step S104 to step S106, in consideration of a region load quantity, the target server of region B is changed to server 3 and migration is performed. In this process, region B migrates twice. As an eventual result, the migration of region B from server 6 to server 3 theoretically can be accomplished by one movement. Therefore, migration in S103 in the foregoing solution can be redundant and the method can be further improved.

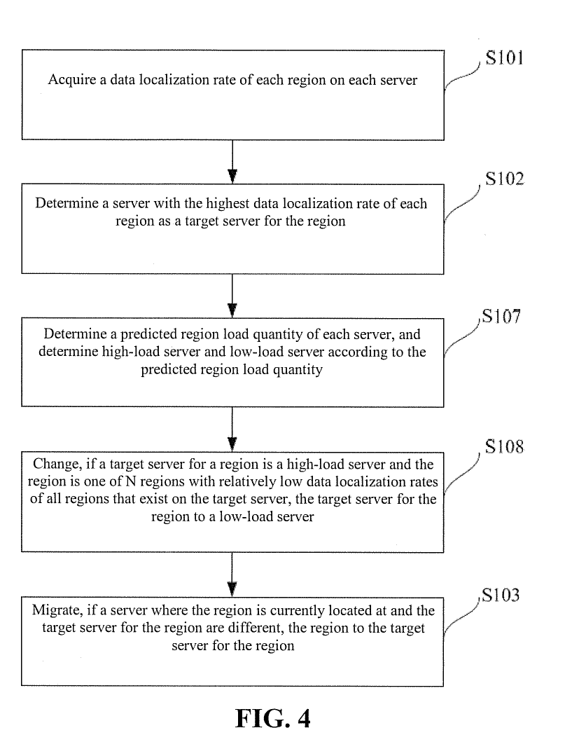

Reference is now made to FIG. 4, which is a flow chart illustrating an exemplary load balancing method, consistent with embodiments of the present disclosure. To avoid possible redundant movement, an embodiment of the present application further provides a load balancing method. With reference to the solution shown in FIG. 2, a processing procedure of the method is shown in FIG. 4. The method includes the following steps.

At step S101, a data localization rate of each region on each server is acquired. The data localization rate is a ratio of local data of the region stored on a physical machine corresponding to a server to total data of the region.

At step S102, a server with the highest data localization rate of each region is determined as a target server corresponding to the region.

At step S107, a predicted region load quantity of each server is determined, and servers can be determined as high load server, low load server, or the like according to the predicted region load quantity. The predicted region load quantity is a quantity of regions that exist on each server if each region migrates to the target server for the region.

At step S108, if a target server of a region is a high-load server and the region is one of N regions with relatively low data localization rates of regions that exist on the target server if each region migrates to the target server for the region, the target server for the region is changed to a low-load server. Here N is a positive integer.

At step S103, if a server where the region is currently located at and the target server for the region are different, the region can migrate to the target server for the region.

In some embodiments, after a server with the highest data localization rate of each region is determined as the target server for the region, a region load quantity that exists on each server after a corresponding region migrates to the determined target server, is predicted by simulated calculation. The target servers of the regions are changed by using the predicted region load quantities and by also considering balancing of region load quantities, and region migration is then performed in a unified manner by considering the target servers determined here. Because operation costs required for simulated calculation are much less than those required for actual migration, redundant migration can be avoided by lowering operation cost. Accordingly, processing expenditure is reduced and the efficiency of load balancing is improved.

The predicted region load quantity used to determine a high-load server and a low-load server is a calculated value obtained based on the target server determined at the first time, and is not an actual value directly acquired by each server. When the predicted region load quantity is used to determine servers as high-load server, low-load server, or the like, and when there are multiple low-load servers, the method of choosing one of the low-load servers as a target server is similar to the foregoing load balancing method shown in FIG. 3, and is not repeated herein for simplicity.

Specifically, at determination step S107, the determination of high-load server and low-load server according to the predicted region load quantity includes determining a server whose predicted region load quantity is greater than a preset load range's upper limit as a high-load server, and determining a server whose predicted region load quantity is less than a preset load range's lower limit as a low-load server.

At change step S108, N is the difference between the predicted region load quantity of the high-load server and an average predicted region load quantity of all servers. Changing the target server for the region to a low-load server further includes changing, when there are multiple low-load servers, the target server for the region to a low-load server with the highest data localization rate of the region according to data localization rates of the region on the low-load servers.

Further, for any load balancing implementation in these embodiments, during migration of multiple regions, the migrating the region to the target server corresponding to the region specifically includes each region sequentially migrating to the target server for the region according to a preset interval time. During region migration, related settings of distributed data storage system 110 may change. Therefore, if an excessive amount of migration is performed within a short time, settings in the system may change too fast, causing jitters in the system. A particular interval time (for example, 100 ms) may be set during migration of each region, thereby preventing jitters caused by region migration.

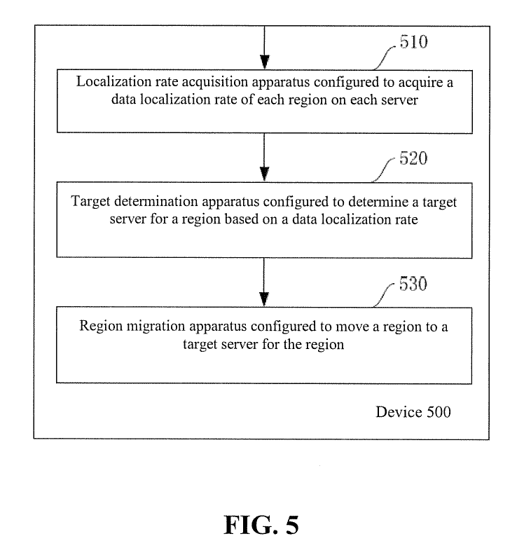

Reference is now made to FIG. 5, which is a schematic diagram illustrating an exemplary load balancing device 500, consistent with embodiments of the present disclosure. Device 500 includes a localization rate acquisition apparatus 510, a target determination apparatus 520, and a region migration apparatus 530.

In these embodiments, device 500 is configured to implement the exemplary methods described with respect to FIG. 2. Localization rate acquisition apparatus 510 is configured to acquire a data localization rate of each region on each server. The data localization rate is a ratio of local data of the region stored on a physical machine corresponding to a server to total data of the region.

Target determination apparatus 520 is configured to determine a server with the highest data localization rate of each region as a target server for the region. Region migration apparatus 530 is configured to migrate, if a server where the region is currently located at and the target server for the region are different, the region to the target server for the region.

As described previously, the data localization rate of a region on each server is acquired, and each region is allocated to a server with the highest localization rate according to the data localization rate. When a data query request is processed, a server to which each region is currently allocated has a relatively high data localization rate and most data can be acquired from a magnetic disk in a local server. As a result, a probability of remotely reading data in a region can be greatly reduced, so that read performance is increased.

Here, device 500 may be a central server in distributed data storage system 110. The central server includes, but is not limited to, implementations such as a network host, a single network server, a set of multiple network servers or a cloud-computing based computer set. Here, a cloud is foil red of a large number of hosts or network servers based on cloud computing. The cloud computing is one type of distributed computing, and is one virtual computer formed of a group of loosely coupled computer sets. The central server can regularly collect data localization rates of a region on servers in a heartbeat report manner.

In some embodiments, localization rate acquisition apparatus 510 can also determine a server with the highest data localization rate of each region according to the acquired data localization rate of each region on each server. The server is a server of a corresponding region and can be used as a target server to which the region migrates. The scenario shown in FIG. 2 is still used as an example. It is assumed that data block 11, data block 12, data block 21, and data block 22 have the same size. In this case, distribution of data localization rates of region A is:

$${A}_{Server 1} = \frac{Block 11 + Block 21}{File 1 + File 2} = 50 \%$$

$${A}_{Server 2} = \frac{Block 12 + Block 22}{File 1 + File 2} = 50 \%$$

$${A}_{Server 3} = \frac{Block 11 + Block 12 + Block 21 + Block 22}{File 1 + File 2} = 100 \%$$

Accordingly, a region migration plan can be generated. Server 3 is determined as the target server for region A. Because the server where region A is currently located at is server 1, which is not the same server as the target server for region A, the region migration plan is executed to move region A to the target server for the region, which is server 3 here. If a server where a region is currently located at and the target server for the region are the same, the server where the region is currently located at already has the highest data localization rate, therefore region migration is unnecessary. After region migration is completed, a data localization rate of region A on server 3 can reach 100%. Accordingly, for any data query request, only local read needs to be performed on a local magnetic disk of a physical machine of server 3 to acquire the required data. Therefore, read performance is greatly improved.

Moreover, quantities of servers, regions, files and data blocks involved in practical application are greater than those shown in FIG. 2 For a server, when data localization rates of several regions are high, the quantity of data blocks of the other regions stored on a physical machine corresponding to the server is generally relatively small because of the storage space restriction. As a result, data localization rates of the other regions on the server are relatively low. Therefore, after region migration is performed according to a data localization rate, the region load quantity on each server is relatively balanced. Servers have similar loads.

Region migration can bring certain processing load to the distributed data storage system 110. To prevent normal operation of the system from being affected by excessive numbers of region migration, migration may not be performed when the migration only slightly increases the data localization rate. In some embodiments, determining step S102 of FIG. 2 can further include, if a difference between the data localization rate of a server where a region is currently located at and the data localization rate of a server with the highest data localization rate of the region is greater than a preset value, determining the server with the highest data localization rate of the region as a target server for the region. The preset value may be set according to application scenario, for example, 10%. Therefore, a server with the highest data localization rate is used as the target server only when the difference between the data localization rate of a region on a current server and the highest data localization rate that can be reached is greater than 10%.

Region A of server 1 in FIG. 1 is used as an example. It is assumed that a data localization rate of region A on server 1 where region A is currently located at is 70%, and data localization rates of the region A on the server 2 and the server 3 are respectively 30% and 75%. In this case, for region A, the server with the highest data localization rate is server 3. However, the difference between the highest data localization rate and the data localization rate on the server where the region A is currently located at is 5%. Overall improvement of read performance after region migration is determined to be not significant. Therefore, migration may not be performed. And the target server of region A may be set to be the server where region A is currently located (server 1 in this case). However, if the data localization rate of the region on server 3 reaches 90%, it is determined that data localization rate can be increased by 20% by region migration. In this case, the read performance is significantly improved. Therefore, server 3 is used as the target server of region A.

After device 500 performs region migration, the data localization rate of each region in distributed data storage system 110 may reach the maximum. At the same time, servers may generally have relatively balanced load. However, in a special circumstance such as a data hotspot or system expansion, data may relatively concentrate on some server nodes. In this case, many regions may be loaded on some servers, while a relatively small quantity of regions are loaded on some other servers. As a result, region load quantities are not balanced. In some embodiments of the present disclosure, a load balancing device is further disclosed.

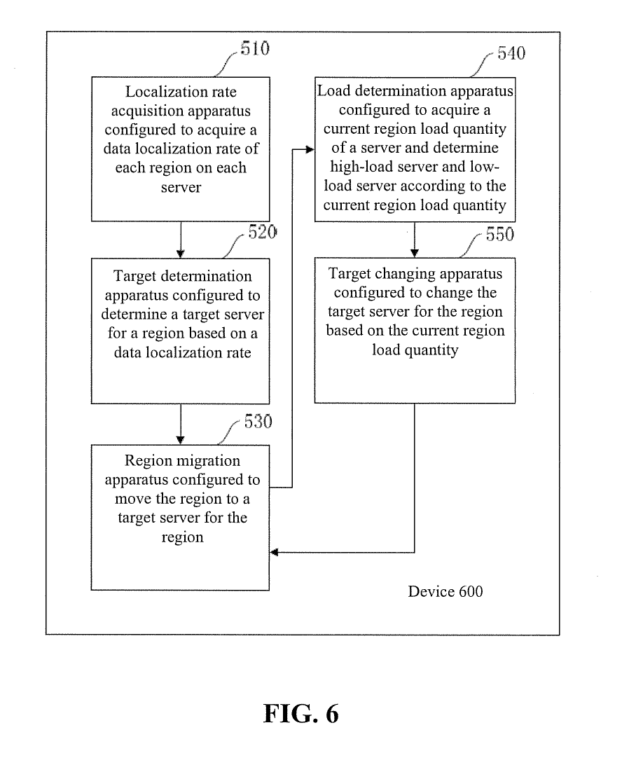

Reference is now made to FIG. 6, which is a schematic diagram illustrating an exemplary load balancing device 600, consistent with embodiments of the present disclosure.

The structure of device 600 is shown in FIG. 6, and further includes a load determination apparatus 540 and a target changing apparatus 550, in addition to localization rate acquisition apparatus 510, target determination apparatus 520, and region migration apparatus 530 shown in FIG. 5.

In these embodiments, device is configured to implement foregoing method disclosed in FIG. 3. Load determination apparatus 540 is configured to acquire a current region load quantity of each server after the region migrates to the target server for the region, and determine high-load server and low-load server according to the current region load quantity. Target changing apparatus 550 is configured to change, if a server where a region is currently located at is a high-load server and the region is one of N regions with relatively low data localization rates of regions on the server where the region is currently located at, the target server for the region to the low-load server. Region migration apparatus 530 is not only configured to move the region according to the target server determined by the target determination apparatus, but also configured to move the region to the target server for the region after the target changing apparatus changes the target server for the region to a low-load server, if a server where the region is currently located at and the target server for the region are different. It is appreciated that localization rate acquisition apparatus 510 and target determination apparatus 520 are respectively the same as the corresponding apparatuses in the embodiment in FIG. 5. They are no longer elaborated here for simplicity, and are included herein by way of reference.

After region migration is performed according to a data localization rate of the regions, another migration is performed to further take into consideration the region load quantities of all servers, thereby reducing the occurrence of unbalanced region load that may be caused by region migration performed only according to a data localization rate, and leading region load quantities of the servers to reach a more balanced state while ensuring data read performance.

The low-load server and the high-load server respectively refer to servers where regions are allocated to have region load quantities that are less than and greater than an average region load quantity, respectively. A preset load range may be set according to the average region load quantity. According to the upper limit value and the lower limit value of the preset load range, a server can be determined to be a low-load server or a high-load server. In some embodiments, load determination apparatus 540 can determine a server whose current region load quantity is greater than a preset load range's upper limit as a high-load server, and determines a server whose current region load quantity is less than a preset load range's lower limit as a low-load server. For example, the upper limit of the preset load range may be set as the average region load quantity×(1+coefficient), and the upper limit of the preset load range may be set as the average region load quantity×(1+coefficient). The coefficient may be set according to application.

For example, the coefficient is set to 0.1 here. If the average region load quantity is 50 by calculation according to the acquired current region load quantity of each server, the upper limit of the preset load range is 50×(1+0.1)=55, and the lower limit of the preset load range is 50×(1-0.1)=45. Accordingly, a server whose current region load quantity is greater than 55 is determined as a high-load server, and a server whose current region load quantity is less than 45 is determined as a low-load server.

For example, if the current region load quantity of the server 3 is 57, it is determined as a high-load server. If the current region load quantity of the server 1 is 40, it is determined as a low-load server. Several regions with the lowest data localization rates on server 3 may migrate to server 1 to make region load more balanced. In this case, the quantity in migration may be determined according to one or more requirements of the application, and one or more regions may migrate. When only one region with the lowest data localization rate migrates, the load can be balanced, although the region load quantity of server 3 cannot be reduced to the preset load range.

In some embodiments, a quantity of regions to be moved from a high-load server to a low-load server may be determined according to the average region load quantity. N used by target changing apparatus 550 is the difference between the current region load quantity of the high-load server and an average current region load quantity of all servers. For example, here a quantity of regions that need to be moved from server 3 is 7. If a region is one of the 7 regions with relatively low data localization rates out of all regions on the server where the region is currently located at, the target server for the region is configured to change to server 1. For the other 6 regions that have relatively low data localization rates, the target servers thereof are similarly changed to low-load servers.

When there are multiple low-load servers, target changing apparatus 550 can change the target server for the region to a low-load server by random allocation. In addition, target changing apparatus 550 can also change the target server for the region to a low-load server with the highest data localization rate of the region according to data localization rates of the region on the low-load servers. For example, server 1 is a high-load server, and server 3, server 4, and server 6 are low-load servers. Region B is a region with the lowest data localization rate on server 1, which is 52%. Data localization rates of region B on server 3, server 4, and server 6 are respectively 40%, 33%, and 17%. Region B can still migrate from a high-load server to a low-load server to ensure balanced region load quantities. During selection of a target server, an optimal server may be selected according to a data localization rate. For example, an optimal low-load server of region B is server 3.

The following case is taken as an example. When localization rate acquisition apparatus 510 acquires a data localization rate of a region, the server where region B is currently located at is server 6, and a data localization rate of region B is 17%. Target determination apparatus 520 determines according to the data localization rate of the region acquired by localization rate acquisition apparatus 510 that the target server of region B is server 1, and a data localization rate of region B is 52%. Region migration apparatus 530 can move, according to the target server determined by target determination apparatus 520, region B to the currently set target server so that region B has a better or optimal data localization rate. However, during subsequent processing, in consideration of a region load quantity, load determination apparatus 540, target changing apparatus 550, and region migration apparatus 530 may further need to change the target server of region B to server 3 and perform migration. In this process, region B migrates twice. As an eventual result, the migration of region B from server 6 to server 3 theoretically can be accomplished by one movement. Therefore, migration performed according to the target server determined by target determination apparatus 520 of a region performed for the first time by region migration apparatus 530 in the foregoing solution can be redundant. Further improvement can be made.

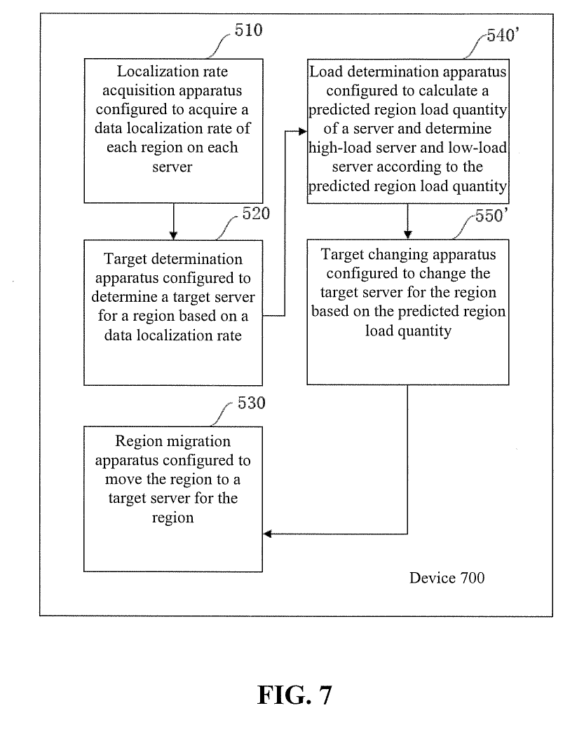

Reference is now made to FIG. 7, which is a schematic diagram illustrating an exemplary load balancing device 700, consistent with embodiments of the present disclosure.

The structure of device 700 is shown in FIG. 7. Device 700 further includes a load determination apparatus 540′ and a target changing apparatus 550′, in addition to localization rate acquire apparatus 510, target determination apparatus 520, and region migration apparatus 530 shown in FIG. 5.

In these embodiments, device is configured to implement the foregoing method disclosed in FIG. 4. Load determination apparatus 540′ is configured to calculate a predicted region load quantity of each server after the server with the highest data localization rate of each region is determined as the target server for the region, and determine high-load server and low-load server according to the predicted region load quantity. The predicted region load quantity is a quantity of regions that exist on each server if each region migrates to the target server for the region. Target changing apparatus 550′ is configured to change the target server for the region to a low-load server, before the region migrates to the target server for the region, if a target server for a region is a high-load server and the region is one of the N regions with relatively low data localization rates of all regions that exist on the target server. It is appreciated that localization rate acquisition apparatus 510, target determination apparatus 520, and region migration apparatus 530 are respectively the same as corresponding apparatuses disclosed in embodiments in FIG. 5. They are no longer elaborated here for simplicity, and are included herein by way of reference.

In the solution, after a server with the highest data localization rate of each region is determined as a target server for the region, a region load quantity that exists on each server after a corresponding region migrates according to the determined target server is predicted by simulated calculation. The target servers of the regions are changed by using the predicted region load quantities and by also considering balancing of region load quantities, and region migration is further performed in a unified manner by considering the target servers determined here. Because operation costs required for simulated calculation are much less than required for actual migration, redundant migration can be avoided by lowering operation cost. Accordingly, processing expenditure is reduced and the efficiency of load balancing is improved.

The predicted region load quantity used by load determination apparatus 540′ to determine high-load server and low-load server is a calculated value obtained based on the target server determined at the first time, and is not an actual value directly acquired by each server. When load determination apparatus 540′ uses the predicted region load quantity to determine high-load server and low-load server, and when there are multiple low-load servers, the method of choosing one of the low-load servers as a target server by target changing apparatus 550′ is similar to the method used by load determination apparatus 540 and target changing apparatus 550 in the foregoing load balancing device 500 shown in FIG. 6.

Specifically, load determination apparatus 540′ is configured to determine a server whose predicted region load quantity is greater than a preset load range's upper limit as a high-load server, and determine a server whose predicted region load quantity is less than a preset load range's lower limit as a low-load server.

N used by target changing apparatus 550′ is the difference between the predicted region load quantity of the high-load server and an average predicted region load quantity of all servers. When there are multiple low-load servers, target changing apparatus 550′ is configured to change the target server for the region to a low-load server with the highest data localization rate of the region according to data localization rates of the region on the low-load servers.

Further, for any load balancing device in these embodiments, during migration of multiple regions, the region migration apparatus 530 sequentially moves each region to the target server corresponding to the region according to a preset interval time. During region migration, related settings of the distributed data storage system may change. Therefore, if an excessive amount of migration is performed within a short time, settings in the system may change too fast, causing jitters in the system. To avoid this condition, a particular interval time (for example, 100 ms) may be set during migration of each region, thereby preventing jitters caused by region migration. In conclusion, in the technical solution provided by the present application, a data localization rate of a region on each server is acquired, and each region is allocated to a server with the highest localization rate according to the data localization rate. When a data query request is processed, because a server to which each region is currently allocated has a relatively high data localization rate and most data can be acquired from a magnetic disk in a local server, a probability of remotely reading data in a region can be greatly reduced, so that read performance is increased. In addition, allocation of a region is further adjusted by using region load quantity, so that when read performance is optimized, a problem that region load may relatively concentrate on some servers in a particular circumstance (for example, a data hotspot or system expansion) can be avoided while read performance is optimized.

It is appreciated that the disclosed embodiments may be implemented in software and/or a combination of software and hardware. For example, embodiments can be implemented by an application-specific integrated circuit (ASIC), a computer, or any other similar hardware device. In some embodiments, software program may be executed by one or more processors to implement the foregoing steps or functions. Software program (including a related data structure) may be stored in a computer readable medium, for example, a RAM, a magnetic drive, an optical drive, a floppy disk, or a similar device. In addition, some steps or functions of embodiments may be implemented by hardware, for example, a circuit that is coupled with a processor to execute the steps or functions.

In addition, a part of these embodiments may be applied as a computer program product, for example, a computer program instruction. When being executed by a computer, the computer program instruction may invoke or provide the methods and/or technical solutions disclosed through the operation of the computer. A program instruction that invokes the method of the present application may be stored in a fixed or removable recording medium, and/or is transmitted through broadcasting or by using a data stream in another signal-bearing medium, and/or is stored in a working memory of a computer device that runs according to the program instruction. In some embodiments, a disclosed apparatus includes a memory configured to store a computer program instruction and a processor configured to execute the program instruction. When the computer program instruction is executed by the processor, the apparatus is triggered to run the methods and/or technical solutions based on the foregoing multiple embodiments according to the present application.

The present application is not limited to the details in the foregoing exemplary embodiments, and the present application can be implemented in other specific forms without departing from the spirit or basic features of the present application. Therefore, from all perspectives, the embodiments should be considered to be exemplary and non-limitative. The scope of the present application is defined by the appended claims instead of the foregoing description. Therefore, all changes that fall within the meanings and scope of equivalent elements of the claims are intended to be covered by the present application. Any reference numeral in the claims should not be construed as limiting the related claims. In addition, apparently, the word “include” does not exclude other units or steps, and a singular form does not exclude a plural one. Multiple units or apparatuses described in the apparatus claims may alternatively be implemented by one unit or apparatus by using software or hardware.

1. A method for load balancing a set of servers, comprising:
acquiring data localization rates for regions for one or more servers of the set of servers, wherein each of the data localization rates is based on amount of local data of a region stored on a physical machine corresponding to a server of the set of servers and amount of total data of the region;
determining a target server for a first region using the data localization rate for the first region on the server; and
migrating the first region to the target server, in response to the server that the first region is currently located at being different from the target server for the first region.

2. The method of claim 1, wherein migrating the first region to the target server in response to a difference between a data localization rate of the server where the first region is currently located at and a data localization rate of the target server being greater than a preset value.

3. The method of claim 1, further comprising:
determining a predicted region load quantity of each server;
determining a high-load server and a low-load server of the set of servers based on the predicted region load quantity, wherein the predicted region load quantity is the quantity of regions on a server after one or more region migrate to the target server; and
changing the target server to the low-load server, in response to the target server being the high-load server and the region having a lower value based on comparison of amount of local data of the region and amount of the total data of the region that would exist on the target server.

4. The method of claim 3, wherein determining the high-load server and the low-load server based on the predicted region load quantity comprises:
determining a server having a predicted region load quantity greater than a preset load range's upper limit as a high-load server; and
determining a server having a predicted region load quantity less than a preset load range's lower limit as a low-load server.

5. The method of claim 3, wherein a number of regions having a lower value based on comparison of amount of local data of a region and amount of the total data of a region is the difference between the predicted region load quantity of the high-load server and the average predicted region load quantity of all servers.

6. The method of claim 1, further comprising:
acquiring a current region load quantity of each server;
determining a high-load server and a low-load server according to the current region load quantity;
changing the target server to the low-load server, in response to a server that a region is currently located at being the high-load server and the region having a lower value based on comparison of amount of local data of the region and amount of the total data of the region on the server that the region is currently located at; and
migrating the region to the target server, in response to the server that the region is currently located at being different from the target server for the region.

7. The method of claim 6, wherein determining the high-load server and the low-load server according to the current region load quantity comprises:
determining a server having a current region load quantity greater than a preset load range's upper limit as the high-load server; and
determining a server having a current region load quantity less than a preset load range's lower limit as the low-load server.

8. The method of claim 6, wherein a number of regions having a lower value based on comparison of amount of local data of a region and amount of the total data of a region is the difference between the current region load quantity of the high-load server and the average current region load quantity of all servers.

9. The method of claim 3, wherein changing the target server to the low-load server comprises:
changing, in response to multiple low-load servers existing, the target server to the low-load server with a higher value based on comparison of amount of local data of the region and amount of the total data of the region according to data localization rates of the region on the low load server.

10. The method of claim 1, wherein migrating the region to the target server further comprises:
migrating a second region to the target server after the first region being migrated to the target server for a preset interval time.

11. The method of claim 1, wherein the target server for the first region is determined based on the data localization rates and the server having the highest data localization rate is determined as the target server.

12. A device for load balancing a set of servers, comprising:
a localization rate acquisition apparatus configured to acquire data localization rates for regions for one or more servers of the set of servers, wherein each of the data localization rates is based on amount of local data of a region stored on a physical machine corresponding to a server of the set of servers and amount of total data of the region;
a target determination apparatus configured to determine a target server for a first region using the data localization rate for the first region on the server; and
a region migration apparatus configured to migrate the first region to the target server, in response to the server that the first region is currently located at being different from the target server for the first region.

13. The device of claim 12, wherein the region migration apparatus is configured to migrate the first region to the target server in response to a difference between a data localization rate of the server where the first region is currently located at and a data localization rate of the target server being greater than a preset value.

14. The device of claim 12, further comprising:
a load determination apparatus configured to
determine a predicted region load quantity of each server;
determine a high-load server and a low-load server of the set of servers based on the predicted region load quantity, wherein the predicted region load quantity is the quantity of regions on a server after one or more region migrate to the target server; and
a target changing apparatus configured to change the target server to the low-load server, in response to the target server being the high-load server and the region having a lower value based on comparison of amount of local data of the region and amount of the total data of the region that would exist on the target server.

15. The device according to claim 14, wherein the load determination apparatus is configured to determine a server having a predicted region load quantity greater than a preset load range's upper limit as a high-load server, and determine a server having a predicted region load quantity less than a preset load range's lower limit as a low-load server.

16. The device according to claim 14 or 15, wherein a number of regions having a lower value based on comparison of amount of local data of a region and amount of the total data of a region is the difference between the predicted region load quantity of the high-load server and the average predicted region load quantity of all servers.

17. The device according to claim 12, wherein the device further comprises:
a load determination apparatus configured to acquire a current region load quantity of each server, and determine a high-load server and a low-load server according to the current region load quantity;
a target changing apparatus configured to change the target server to the low-load server, in response to a server that a region is currently located at being the high-load server and the region having a lower value based on comparison of amount of local data of the region and amount of the total data of the region on the server that the region is currently located at, and
the region migration apparatus is further configured to migrate the region to the target server, in response to the server that the region is currently located at being different from the target server for the region.

18. The device of claim 17, wherein the load determination apparatus is configured to determine a server having a current region load quantity greater than a preset load range's upper limit as the high-load server, and determine a server having a current region load quantity less than a preset load range's lower limit as the low-load server.

19. The device of claim 17, wherein a number of regions having a lower value based on comparison of amount of local data of a region and amount of the total data of a region is the difference between the current region load quantity of the high-load server and the average current region load quantity of all servers.

20. The device of claim 14, wherein the target changing apparatus is configured to change, in response to multiple low-load servers existing, the target server to the low-load server with a higher value based on comparison of amount of local data of the region and amount of the total data of the region according to data localization rates of the region on the low load server.

21. The device of claim 12, wherein the region migration apparatus is configured to migrate a second region to the target server after the first region being migrated to the target server for a preset interval time.

22. The device of claim 12, wherein the target server for the first region is determined based on the data localization rates and the server having the highest data localization rate is determined as the target server.

23. A non-transitory computer readable medium storing a set of instructions that is executable by one or more processors of a load balancing system to cause the load balancing system to perform a method comprising:
acquiring data localization rates for regions for one or more servers of the set of servers, wherein each of the data localization rates is based on amount of local data of a region stored on a physical machine corresponding to a server of the set of servers and amount of total data of the region;
determining a target server for a first region using the data localization rate for the first region on each server; and
migrating the first region to the target server, in response to the server that the first region is currently located at being different from the target server for the first region.

24. A non-transitory computer readable medium of claim 23,
wherein migrating the first region to the target server in response to a difference between a data localization rate of the server where the first region is currently located at and a data localization rate of the target server being greater than a preset value.

25. The non-transitory computer readable medium of claim 23, wherein the set of instructions that is executable by the one or more processors of the load balancing system to cause the load balancing system to further perform:
determining a predicted region load quantity of each server;
determining a high-load server and a low-load server of the set of servers based on the predicted region load quantity, wherein the predicted region load quantity is the quantity of regions on a server after one or more region migrate to the target server; and
changing the target server to the low-load server, in response to the target server being the high-load server and the region having a lower value based on comparison of amount of local data of the region and amount of the total data of the region that would exist on the target server.

26. The non-transitory computer readable medium of claim 25, wherein determining the high-load server and the low-load server based on the predicted region load quantity comprises:
determining a server having a predicted region load quantity greater than a preset load range's upper limit as a high-load server; and
determining a server having a predicted region load quantity less than a preset load range's lower limit as a low-load server.

27. The non-transitory computer readable medium of claim 25, wherein a number of regions having a lower value based on comparison of amount of local data of a region and amount of the total data of a region is the difference between the predicted region load quantity of the high-load server and the average predicted region load quantity of all servers.

28. The non-transitory computer readable medium of claim 23, wherein the set of instructions that is executable by the one or more processors of the load balancing system to cause the load balancing system to further perform:
acquiring a current region load quantity of each server;
determining a high-load server and a low-load server according to the current region load quantity;
changing the target server to the low-load server, in response to a server that a region is currently located at being the high-load server and the region having a lower value based on comparison of amount of local data of the region and amount of the total data of the region on the server that the region is currently located at; and
migrating the region to the target server, in response to the server that the region is currently located at being different from the target server for the region.

29. The non-transitory computer readable medium of claim 28, wherein determining the high-load server and the low-load server according to the current region load quantity comprises:
determining a server having a current region load quantity greater than a preset load range's upper limit as the high-load server; and
determining a server having a current region load quantity less than a preset load range's lower limit as the low-load server.

30. The non-transitory computer readable medium of claim 28, wherein a number of regions having a lower value based on comparison of amount of local data of a region and amount of the total data of a region is the difference between the current region load quantity of the high-load server and the average current region load quantity of all servers.

31. The non-transitory computer readable medium of claim 25, wherein changing the target server to the low-load server comprises:
changing, in response to multiple low-load servers existing, the target server to the low-load server with a higher value based on comparison of amount of local data of the region and amount of the total data of the region according to data localization rates of the region on the low load server.

32. The non-transitory computer readable medium of claim 23, wherein migrating the region to the target server further comprises:
migrating a second region to the target server after the first region being migrated to the target server for a preset interval time.

33. The non-transitory computer readable medium of claim 23, wherein the target server for the first region is determined based on the data localization rates and the server having the highest data localization rate is determined as the target server.
